(19) United States
(12) Patent Application Publication
(10) Pub. No.: US 2026/0171281 A1
(43) Pub. Date: Jun. 18, 2026

(54) CONDUCTIVE FILM

(71) Applicant: Panasonic Intellectual Property Management Co., Ltd., Kadoma-shi, Osaka (JP)

(72) Inventors: Takumi Ochiai, Nara (JP); Ryosuke Yatsuzuka, Osaka (JP); Wataru Tamura, Osaka (JP)

(73) Assignee: Panasonic Intellectual Property Management Co., Ltd., Kadoma-shi, Osaka (JP)

(21) Appl. No.: 19/128,317

(22) PCT Filed: Oct. 10, 2023
(86) PCT No.: PCT/JP2023/036769

§ 371 Date: May 8, 2025

(30) Foreign Application Priority Data
Nov. 24, 2022 (JP) 2022-187212

(51) Int. Cl. H01B 1/02; C22C 19/00; C22C 19/03

(52) U.S. Cl. CPC H01B 1/026; C22C 19/002; C22C 19/03

(57) ABSTRACT

A conductive film includes: a substrate and a conductive layer provided on at least one surface of the substrate, wherein the conductive layer and the substrate are in contact with each other through a fine particle layer, the fine particle layer includes fine metal particles that absorb light, and an interface between the conductive layer and the fine particle layer has an uneven structure.

### TECHNICAL FIELD

The present disclosure relates to a conductive film used as a wiring board or the like.

### BACKGROUND ART

Electrical equipment uses a wiring board in which wiring is formed in a substrate. The wiring board is used as a touch sensor board provided with sensor electrodes, or as a mounting board where electronic components such as circuit elements are mounted. For example, a touch panel, which includes a touch sensor board in which fine wiring that serves as a sensor electrode is formed in a mesh shape on a transparent film substrate, is known as an electrical device using a wiring board as a touch sensor board. The fine wiring is, for example, a metal wiring such as copper wiring with a line width with a size of the order of micrometers.

As a technology for forming fine wiring with a size of the order of micrometers, there is a technology in which grooves are formed in the insulating substrate itself or in the insulating layer on the substrate, and wiring is embedded within the grooves. As a technique of this type, for example, the imprinting method is known. The imprinting method is a technique in which a mold member (mold) having a fine uneven structure is used to transfer the uneven structure to an insulating substrate made of a resin material or to a resin insulating layer on a substrate to form fine grooves, and wiring is embedded within the grooves.

As a method for embedding wiring into grooves formed in an insulating substrate made of a resin material or in a resin insulating layer on a substrate, a technique for forming wiring by plating is known. In this case, first, a seed layer serving as an underlying layer is formed by sputtering on the entire surface of the insulating substrate or resin insulating layer having grooves, a plating layer is then stacked on the seed layer by electrolytic plating, and then the excess seed layer and plating layer are removed. This allows fine metal wiring, in which a plating layer (metal layer) serving as the main wiring layer is stacked on a seed layer, to be embedded within the groove.

Fine metal wiring with a line width of at most 100 μm is difficult to recognize by the naked eye. For this reason, a wiring board in which fine metal wiring with a line width of at most 100 μm is formed on the transparent resin film substrate feels like a transparent film. However, even if the fine metal wiring has a line width of at most 100 μm, the presence of the metal wiring may be recognized depending on the angle of view or the like due to the surface reflection of the metal wiring or the like.

Then, in order to make fine metal wiring less visible, a technology for forming a black film that serves as a low-reflection film on the back surface of the metal wiring is being considered. For example, when metal wiring is formed by the plating method as described above, it is conceivable to make the seed layer, which is a conductive layer, into a black film, or to form a black film on the back side of the plating layer (metal layer) or seed layer (conductive layer), or to apply the blackening treatment to the back side of the seed layer or plating layer.

As a technology related to this type of black film, Patent Literature (PTL) 1 discloses a product for blackening treatment that can be subjected to a treatment (blackening treatment) that reduces the reflectance without roughening the surface of a copper-based metal or silver-based metal. In addition, PTL 2 discloses a wiring board including a catalytic transparent underlying layer (conductive layer) formed on a transparent film, a transparent insulating layer formed on the underlying layer and having trench grooves, a metal layer that is the main wiring layer formed to fill the trench grooves, and a black film formed between the metal layer and the insulating layer.

### CITATION LIST

### Patent Literature

[PTL 1] Japanese Patent No. 5862916

[PTL 2] Japanese Unexamined Patent Application Publication No. 2019-29658

### SUMMARY OF INVENTION

### Technical Problem

However, since the black film generally has a large electrical resistance and is difficult to function as the main wiring layer by itself, it is necessary to form a separate metal layer that serves as the main wiring layer. For that reason, the method of forming a black film separately requires additional manufacturing processes or longer tact time, resulting in increased manufacturing costs or decreased productivity.

Furthermore, even if a black film is formed on the back side of the metal wiring, if the black film is thin, light will pass through, and the light that has passed through the black film will be reflected at the interface between the metal wiring and the black film. On one hand, if the black film is thickened to avoid this, the overall thickness of the wiring board becomes thicker. For this reason, when the black film is made thick, for a film-like wiring substrate such as a conductive film where thinness is required, not only is a step for adding a black film necessary, but a step for pre-grinding the substrate surface is also required, resulting in increased manufacturing costs, decreased productivity, and design limitations.

On the other hand, since in the blackening treatment by the post-treatment, only the exposed portions on the surface are subject to treatment, only the exposed portions on the surface can be blackened. For this reason, when the purpose is to reduce the reflectance of the portion on the back side of the metal wiring (specifically, the reflectance of the interface between the substrate and the conductive layer), no method of the blackening treatment can be adopted.

The present disclosure has been made to solve such problems, and an object of the present disclosure is to provide a conductive film or the like having a structure that can reduce the reflectance of the interface between the substrate and the conductive layer without adding a black film.

### Solution to Problem

To achieve the above object, one aspect of the conductive film according to the present disclosure includes: a substrate that is light-transmissive; and a conductive layer provided on at least one surface of the substrate, wherein the conductive layer and the substrate are in contact with each other through a fine particle layer, the fine particle layer includes fine metal particles that absorb light, and an interface between the conductive layer and the fine particle layer has an uneven structure.

### Advantageous Effects of Invention

It is possible to realize a conductive film having a structure that can reduce the reflectance at the interface between the substrate and the conductive layer without adding a black film.

### BRIEF DESCRIPTION OF DRAWINGS

FIG. 1 is a diagram showing a conductive film according to an embodiment.

FIG. 2 is a partial cross-sectional view of the conductive film according to the embodiment.

FIG. 3 is a diagram for explaining a method for manufacturing a conductive film according to the embodiment.

FIG. 4 is a diagram for explaining a step for forming a conductive layer on a substrate in the method for manufacturing a conductive film according to the embodiment.

FIG. 5 is a cross-sectional SEM image showing a surrounding portion of a fine particle layer in the conductive film actually produced.

FIG. 6 is a diagram showing the results of composition analysis of metals in the conductive layer and the fine particle layer in the conductive film actually produced.

FIG. 7 is a diagram showing the cross-sectional SEM images of the surrounding portion of the fine particle layer and the wavelength dependence of the reflectance for three conductive films actually produced by different thicknesses of the fine particle layer.

FIG. 8 is a diagram showing the cross-sectional SEM images of the surrounding portion of the fine particle layer and the wavelength dependence of the reflectance for three conductive films actually produced by different thicknesses of the fine particle layer.

FIG. 9A is a diagram showing cross-sectional SEM images before and after the test in samples of two types of conductive films with different compositions of fine particle layers (fine metal particles).

FIG. 9B is a diagram showing the wavelength dependence of reflectance after the test in the samples of the two types of conductive films of FIG. 9A.

FIG. 10 is a diagram showing the results of measurement of reflectance after reliability tests for six samples with different Cu/Ni composition ratios in the fine particle layer.

### DESCRIPTION OF EMBODIMENT

Hereinafter, an embodiment of the present disclosure will be described with reference to the accompanying drawings. It should be noted that each of the embodiments described below shows a specific example of the present disclosure. The numerical values, shapes, materials, components, arrangement positions and connection forms of the components, steps, order of steps, and the like shown in the following embodiments are examples, and are not intended to limit the present disclosure. Therefore, among the components in the following embodiments, the components not described in the independent claims indicating the broadest concept of the present disclosure are described as arbitrary components.

It should be noted that each figure is a schematic view and is not necessarily exactly illustrated. Therefore, the scales and the like in each figure do not necessarily match. In addition, in each figure, the same reference numerals are assigned to substantially the same feature, and duplicate descriptions will be omitted or simplified. In addition, as used herein, the terms “upper” and “lower”, “above” and “below”, and “up” and “down” do not necessarily refer to the upward (vertical upward) and downward (vertical downward) in absolute spatial recognition.

### EMBODIMENT

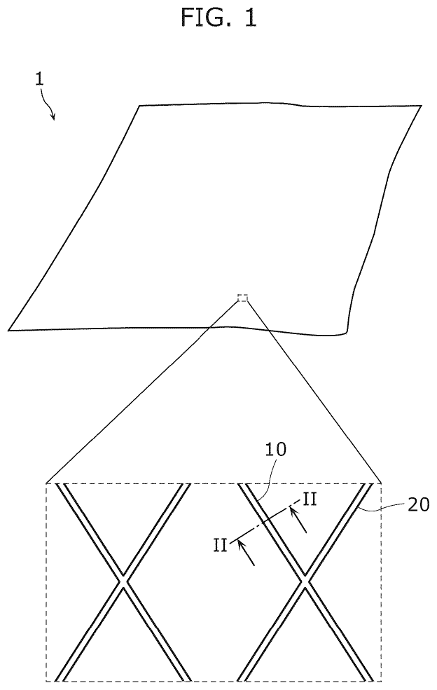

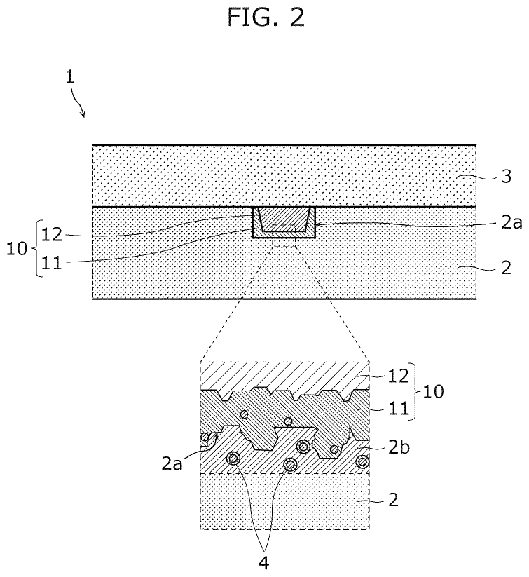

First, the configuration of conductive film 1 according to an embodiment will be described with reference to FIG. 1 and FIG. 2. FIG. 1 is a diagram showing conductive film 1 according to the embodiment. FIG. 2 is a partial cross-sectional view of conductive film 1 according to the embodiment. FIG. 2 shows a cross-section taken along line II-II in FIG. 1.

Conductive film 1 in the present embodiment is a wiring board in which wiring is formed as a conductor. Specifically, conductive film 1 is a flexible wiring board in the form of a film with flexibility. In addition, conductive film 1 is a light-transmitting wiring board that is capable of transmitting light. For example, conductive film 1 is a transparent wiring board in which fine wiring is formed in a transparent substrate.

As shown in FIG. 1, conductive film 1 includes first wiring 10 and second wiring 20 as wirings. In the present embodiment, first wiring 10 and second wiring 20 are formed on the same plane. That is, first wiring 10 and second wiring 20 are integral. It should be noted that first wiring 10 and second wiring 20 may be positioned on separate planes and may be formed to be three-dimensionally intersecting.

First wiring 10 extends in the first direction, and second wiring 20 extends in the second direction intersecting the first direction. In the present embodiment, first wiring 10 and second wiring 20 are not orthogonal, but may be orthogonal.

A plurality of first wirings 10 and second wirings 20 are each formed. For example, first wiring 10 and second wiring 20 are formed throughout conductive film 1 so as to be in a mesh form. First wiring 10 and second wiring 20 are fine wirings having a line width with a size of the order of micrometers. As an example, the line width of each of first wiring 10 and second wiring 20 is at most 100 μm, and in the present embodiment, it is at most 10 μm.

As shown in FIG. 2, conductive film 1 includes substrate 2 and insulating layer 3 formed above substrate 2. It should be noted that insulating layer 3 may not be formed. That is, conductive film 1 may include only substrate 2 on which first wiring 10 and second wiring 20 are formed.

Substrate 2 is an insulating substrate having insulating properties. For example, substrate 2 is a resin substrate with insulating properties which includes an insulating resin material. In addition, substrate 2 is a sheet-like film base material with flexibility, and serves as the base film for conductive film 1.

In the present embodiment, substrate 2 is light-transmissive. Specifically, substrate 2 is a film base material that is transparent to at least visible light, and includes an insulating resin material that is light-transmissive. In this case, substrate 2 may be a transparent resin substrate including a transparent resin material having a high transmittance to the extent that the other side can be seen through.

As the resin material with light transmittance included in substrate 2, for example, polyethylene terephthalate (PET) resin, polyimide resin, cycloolefin resin, polycarbonate resin, acrylic resin, or the like can be used.

Insulating layer 3 is located above substrate 2. In the present embodiment, insulating layer 3 is formed directly above substrate 2. Therefore, the upper surface of substrate 2 is in contact with the lower surface of insulating layer 3.

Insulating layer 3 is a resin layer including an insulating resin material. In the present embodiment, insulating layer 3 includes an insulating resin material that is light-transmissive. Specifically, insulating layer 3 includes a transparent insulating resin material. The resin material included in insulating layer 3 is a thermosetting resin or an ultraviolet curable resin. As the resin material included in insulating layer 3, for example, PET resin, polyimide resin, cycloolefin resin, polycarbonate resin, acrylic resin, or the like can be used. Insulating layer 3 may be fixed to substrate 2 by a transparent adhesive layer (not shown). Insulating layer 3 functions, for example, as a protective film.

Substrate 2 includes groove 2a. Groove 2a is a groove-shaped concave portion formed so that the surface of substrate 2 is recessed, and is formed into a long shape. Specifically, groove 2a is formed in a linear or curved shape. In the present embodiment, groove 2a is linear and is formed only on one surface of substrate 2. Groove 2a is formed to correspond to first wiring 10. For example, a plurality of grooves 2a are formed in substrate 2 so as to be parallel to each other at a predetermined interval. It should be noted that although not shown, a groove corresponding to second wiring 20 is also formed in substrate 2. Groove 2a corresponding to second wiring 20 is the same as groove 2a corresponding to first wiring 10.

Groove 2a includes a bottom surface and a side surface that is continuously connected to the bottom surface. In the present embodiment, when groove 2a is cut in a cross-section perpendicular to the longitudinal direction of groove 2a, the cross-section of groove 2a is in a rectangular shape. In this cross-section, groove 2a includes a planar bottom surface and a pair of side surfaces each having a planar shape and facing each other. Substrate 2 including grooves 2a may be formed by an imprinting method, or by cutting out the surface of the flat base material with a laser scribing or the like.

First wiring 10 is provided on one surface of substrate 2. First wiring 10 is a metal wiring, and includes conductive layer 11 and metal layer 12 stacked on conductive layer 11. Therefore, conductive layer 11 and metal layer 12 are provided on one surface of substrate 2. In the present embodiment, first wiring 10 is provided on only one surface of substrate 2. Therefore, conductive layer 11 and metal layer 12 are provided only on one surface of substrate 2.

First wiring 10 is embedded within groove 2a provided on one surface of substrate 2. Therefore, when first wiring 10 is cut in a cross-section perpendicular to the longitudinal direction of first wiring 10, the cross-sectional shape of first wiring 10 is the same as the cross-sectional shape of groove 2a, and in the present embodiment, the cross-sectional shape of first wiring 10 is rectangular.

Conductive layer 11 is formed in groove 2a of substrate 2. Specifically, conductive layer 11 is formed along the inner surface of groove 2a. That is, conductive layer 11 is formed in a thin film to cover the bottom and side surfaces of groove 2a without completely filling groove 2a.

Conductive layer 11 includes a conductive material. In the present embodiment, conductive layer 11 is a seed layer that serves as an underlying layer for forming metal layer 12 by a plating method. Therefore, conductive layer 11 preferably includes a conductive material with a low electrical resistance. For example, conductive layer 11 is a metal layer (metal film) that includes a metal material containing copper with a low electrical resistance. In this case, conductive layer 11 may include copper only, but may contain copper and other metals such as nickel. In the present embodiment, conductive layer 11 includes copper and nickel. Specifically, conductive layer 11 is a CuNi plating film, and is formed by an electroless plating method.

It should be noted that conductive layer 11 may not be formed by the electroless plating method. For example, conductive layer 11 may be formed by a sputtering method or the like. In addition, although conductive layer 11 is a single film including only one metal film, the present disclosure is not limited thereto. Specifically, conductive layer 11 may be a stacked film in which a plurality of metal films are stacked.

Below conductive layer 11, fine particle layer 2b exists. Conductive layer 11 and substrate 2 are in contact with each other through fine particle layer 2b. Fine particle layer 2b is a layer containing fine metal particles 4 that absorb light. Fine metal particles 4 not only absorb light, but also scatter and reflect light. Specifically, fine metal particles 4 absorb, scatter, or reflect visible light.

Fine metal particles 4 are nanoparticles with a particle size of the order of nanometers. Fine metal particles 4, which are nanoparticles, can absorb visible light of a specific wavelength by localized surface plasmon resonance. In addition, fine metal particles 4, which are nanoparticles, have the properties that exhibit different light reduction depending on the particle size.

A plurality of fine metal particles 4 are randomly present in fine particle layer 2b. The particle size of the plurality of fine metal particles 4 present in fine particle layer 2b is at least 10 nm and at most 30 nm. It should be noted that fine particle layer 2b may contain fine metal particles 4 having a particle size of at most 10 nm. Fine particle layer 2b is a layer in which most (for example, at least 50%) of fine metal particles 4 of the plurality of fine metal particles 4 present in fine particle layer 2b are metal particles 4 with a particle size of at least 10 nm and at most 30 nm. In fine particle layer 2b, the cross-sectional density of fine metal particles 4 having a particle size of at least 10 nm is 1×10³ particles/μm² to 3×10³ particles/μm².

In the present embodiment, fine metal particles 4 include copper and nickel. Specifically, fine metal particles 4 are fine particles made of copper nickel alloy formed by growing copper and nickel using palladium particles (Pd particles) having a particle size of several nm as the core.

Fine particle layer 2b is a part of substrate 2, which is a resin substrate. Specifically, fine particle layer 2b is a surface layer that exists near the surface of substrate 2. Therefore, fine particle layer 2b contains the resin material included in substrate 2. It should be noted that fine particle layer 2b may not contain the resin material included in substrate 2. The thickness of fine particle layer 2b is less than the thickness of conductive layer 11. As an example, the thickness of fine particle layer 2b is at least 30 nm and at most 150 nm.

Fine particle layer 2b and conductive layer 11 are in contact with each other. In the present embodiment, the interface between conductive layer 11 and fine particle layer 2b has an uneven structure. That is, the lower surface of conductive layer 11 and the upper surface of fine particle layer 2b have an even structure. In the present embodiment, since fine particle layer 2b is part of substrate 2, which is a resin substrate, the interface between conductive layer 11 and substrate 2 (resin) has an uneven structure. This uneven structure includes countless concave portions and countless convex portions with random depths and heights. The surface roughness Ry of this uneven structure is in a size of the order of nanometers, and specifically, is at least 10 nm and at most 50 nm. In this way, the interface between conductive layer 11 and fine particle layer 2b is a nano-anchored structure due to the uneven structure.

It should be noted that although fine metal particles 4 may be present outside fine particle layer 2b, the density of fine metal particles 4 in fine particle layer 2b is the highest in conductive film 1. That is, the density of fine metal particles 4 in fine particle layer 2b is higher than the density of fine metal particles 4 in the portion other than fine particle layer 2b of conductive film 1. Specifically, the density of fine metal particles 4 in fine particle layer 2b is higher than the density of fine metal particles 4 in substrate 2 (a portion other than fine particle layer 2b of substrate 2) or conductive layer 11. In the present embodiment, fine metal particles 4 are present only in fine particle layer 2b. That is, the density of fine metal particles 4 in substrate 2 or conductive layer 11 is zero.

Metal layer 12 stacked on conductive layer 11 is formed as an example of a conductive layer. Metal layer 12 is the main wiring layer of first wiring 10. Therefore, metal layer 12 is thicker than conductive layer 11. Metal layer 12 is formed so as to fill groove 2a, the inner surface of which is covered with conductive layer 11. Metal layer 12 is included in most of groove 2a. As an example, metal layer 12 accounts for at least 80% of first wiring 10 in the cross-sectional view of FIG. 2.

Metal layer 12 comprises a metal material such as copper, aluminum, or silver. In the present embodiment, metal layer 12, which is the main wiring layer, comprises copper. Therefore, first wiring 10 is a copper wiring. In this case, metal layer 12 may comprise copper alone or copper alloy.

In addition, metal layer 12 is a plating film formed by a plating method using conductive layer 11 as the underlying layer (seed layer). In the present embodiment, specifically, metal layer 12 is an electroplating film formed by an electroplating method. Specifically, metal layer 12 is a Cu plating film comprising copper.

Second wiring 20 is a metal wiring, and includes a metal layer as the main wiring layer. In the present embodiment, second wiring 20 has the same structure as first wiring 10. Specifically, second wiring 20 is a copper wiring, and has a stacked structure of a conductive layer, which is a CuNi plating film formed by an electroless plating method, and a metal layer, which is a Cu plating film formed by an electrolytic plating method.

It should be noted that for example, when first wiring 10 and second wiring 20 are disposed on different planes, and the like, second wiring 20 may have a different structure from first wiring 10, or may comprise a metal material different from first wiring 10. In this case, first wiring 10 and second wiring 20 can be insulated through insulating layer 3, second wiring 20 can be an upper wiring formed in insulating layer 3 above first wiring 10, and first wiring 10 can be a lower wiring formed below insulating layer 3.

In this way, in conductive film 1 according to the present embodiment, conductive layer 11 and substrate 2 are in contact with each other through fine particle layer 2b which absorbs light, and the interface between conductive layer 11 and fine particle layer 2b, which is the surface layer of substrate 2, has an uneven structure.

With this configuration, light incident from the back side of first wiring 10 is absorbed by fine particle layer 2b containing fine metal particles 4, and is also diffusely reflected by the uneven structure at the interface between conductive layer 11 and fine particle layer 2b. In addition, light incident from the back side of first wiring 10 is also scattered by fine metal particles 4 contained in fine particle layer 2b. In this way, in conductive film 1 according to the present embodiment, fine particle layer 2b is formed at the interface between substrate 2 and conductive layer 11 as a low reflective layer having a low reflectance. This can reduce the reflectance at the interface between substrate 2 and conductive layer 11. Therefore, when conductive film 1 is viewed from the back side, it is possible to make it difficult to recognize first wiring 10.

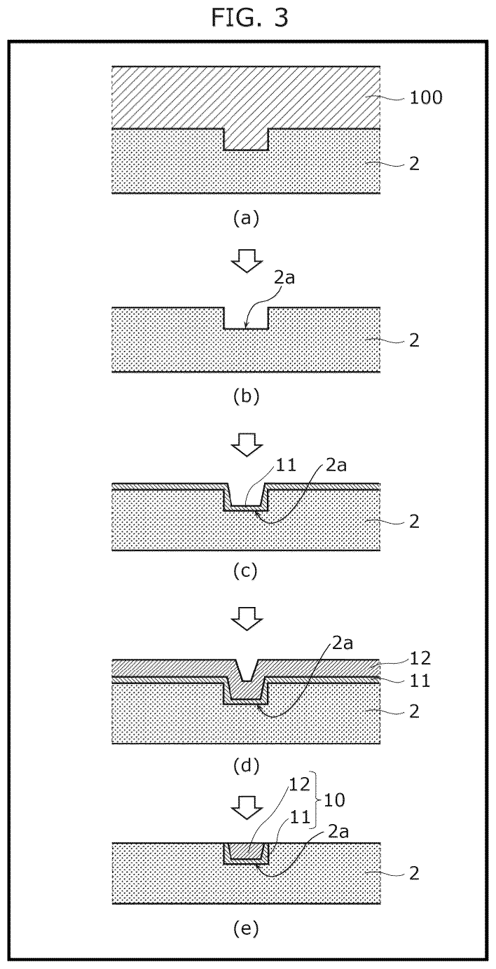

Next, a method for manufacturing conductive film 1 according to the embodiment will be described with reference to FIG. 3. FIG. 3 is a diagram for explaining a method for manufacturing conductive film 1 according to the embodiment.

First, substrate 2 including groove 2a is prepared. For example, substrate 2 including grooves 2a can be fabricated by an imprinting method. In this case, as shown in (a) in FIG. 3, substrate 2 made of thermoplastic resin is first prepared, and the temperature is increased to soften substrate 2, and mold member (mold) 100 that serves as a transfer plate is pressed against substrate 2, thereby forming groove 2a on substrate 2. After that, mold member 100 is removed. Accordingly, as shown in (b) in FIG. 3, substrate 2 including groove 2a can be fabricated.

It should be noted that substrate 2 including groove 2a may be fabricated by a light imprinting method using a photocurable resin, rather than a thermal imprinting method using a thermoplastic resin. In this case, the liquid photocurable resin is sandwiched between the first mold member, which serves as a transfer plate, and the second mold member, and irradiated with light (ultraviolet rays), thereby curing the photocurable resin. After that, the first mold member and the second mold member are removed. This allows groove 2a to be formed in substrate 2 comprising photocurable resin. In addition, substrate 2 may be formed of a thermosetting resin rather than a photocurable resin.

Next, as shown in (c) in FIG. 3, conductive layer 11 is formed on the inner surface of groove 2a. Specifically, conductive layer 11 is formed not only on groove 2a, but also on the entire surface of substrate 2 other than groove 2a. That is, conductive layer 11 is formed over the entire surface of substrate 2. In the present embodiment, conductive layer 11 made of a CuNi plating film is formed by an electroless plating method. It should be noted that this step will be described in detail later.

Next, as shown in (d) in FIG. 3, metal layer 12 is formed on conductive layer 11. Specifically, metal layer 12 is formed over the entire surface of conductive layer 11 so that groove 2a is filled with metal layer 12. In the present embodiment, metal layer 12 was formed by an electrolytic plating method. Specifically, metal layer 12 made of a Cu plating film was formed on conductive layer 11 using conductive layer 11 as a seed layer.

Next, as shown in (e) in FIG. 3, a part of substrate 2 above which conductive layer 11 and metal layer 12 have been formed is removed to form first wiring 10 consisting of conductive layer 11 and metal layer 12. Specifically, conductive layer 11 and metal layer 12 are removed until the surface of substrate 2 in portions where groove 2a is not formed is exposed. That is, unnecessary portions of conductive layer 11 and metal layer 12 are removed so as to leave conductive layer 11 and metal layer 12 embedded in groove 2a. This allows substrate 2 to be obtained in which first wiring 10 is embedded in groove 2a.

It should be noted that although not shown, after that, insulating layer 3 including a groove in which second wiring 20 is embedded is formed on substrate 2 in which first wiring 10 is formed. This makes it possible to fabricate conductive film 1 shown in FIG. 1 and FIG. 2.

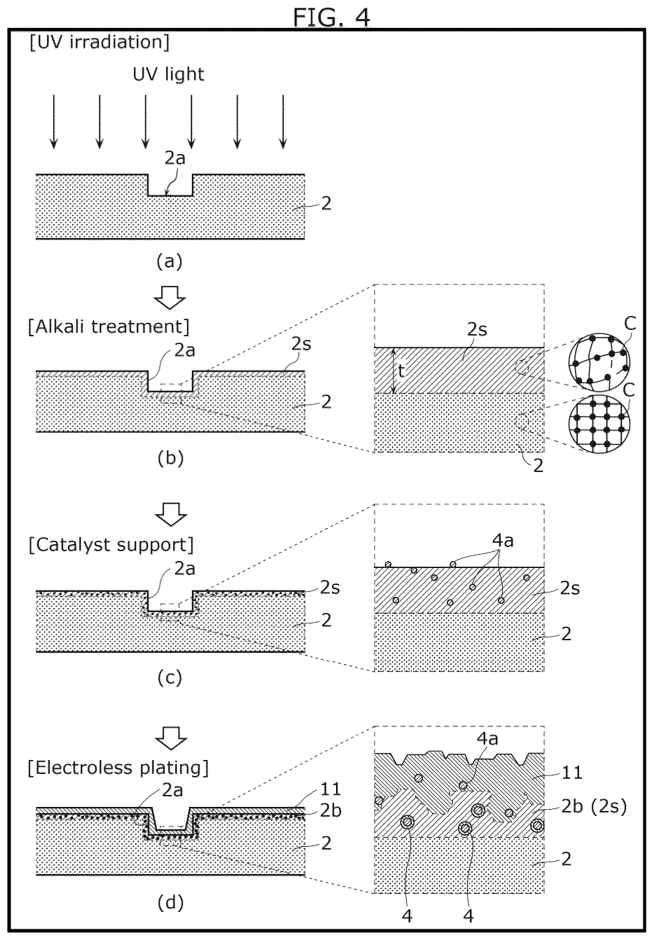

Here, the step of forming conductive layer 11 on substrate 2 (step (c) in FIG. 3) will be described in detail with reference to FIG. 4. FIG. 4 is a diagram for explaining the step for forming conductive layer 11 on substrate 2 in the method for manufacturing conductive film 1 according to the embodiment.

In this step, as shown in (a) in FIG. 4, the surface of substrate 2 on which groove 2a has been formed is irradiated with ultraviolet rays. This allows the C═C bonds present in the surface layer of substrate 2 to be cut. In the present embodiment, a low-pressure mercury lamp was used to irradiate the entire surface of substrate 2 with ultraviolet rays including two peak wavelengths at 185 nm and 256 nm.

Next, as shown in (b) in FIG. 4, an alkali treatment is performed. Specifically, substrate 2 irradiated with ultraviolet rays is immersed in an aqueous NaOH solution. In this way, by performing an alkali treatment after irradiation with ultraviolet rays, the C═C bond present in the surface layer of substrate 2 can be cut to impart a functional group. This allows modified layer 2s in which the surface layer of substrate 2 is modified can be formed near the surface of substrate 2. Thickness t of modified layer 2s formed at this time is at least 30 nm and at most 150 nm.

Next, as shown in (c) in FIG. 4, substrate 2 is supported with catalyst 4a. In the present embodiment, palladium particles (Pd particles) having a particle size of 5 nm were used as catalyst 4a.

Specifically, first, substrate 2 is cleaned by performing a cleaner treatment with a cleaner. After that, substrate 2 is immersed in an aqueous PdCl₂ solution, and Pd particles are supported on substrate 2 as catalyst 4a.

At this time, since modified layer 2s is formed near the surface of substrate 2, catalyst 4a (Pd particles) can be penetrated not only through the surface of substrate 2 but also into the interior of substrate 2. Specifically, catalyst 4a can be penetrated into the interior of modified layer 2s.

Next, as shown in (d) in FIG. 4, conductive layer 11 is formed above substrate 2. In the present embodiment, conductive layer 11 is formed by an electroless plating method. Specifically, substrate 2 on which catalyst 4a is supported is immersed in a CuNi plating solution. Accordingly, copper and nickel are deposited and grown by catalytic reaction by catalyst 4a (Pd particles) supported on substrate 2, and a CuNi plating film, which is an electroless plating film, is formed above substrate 2 as conductive layer 11.

At this time, since catalyst 4a is scattered even into the interior of modified layer 2s of substrate 2, copper and nickel are deposited by catalyst 4a existing inside modified layer 2s. That is, copper and nickel grow with catalyst 4a (Pd particles) as the core, forming countless fine metal particles 4 made of copper-nickel alloy. Accordingly, modified layer 2s, which is the surface layer of substrate 2, becomes fine particle layer 2b containing countless fine metal particles 4.

In this way, by applying an electroless plating process to substrate 2 on which catalyst 4a is supported, conductive layer 11 made of a plating film is stacked on substrate 2 by catalyst 4a, and fine particle layer 2b containing fine metal particles 4 is also formed. That is, a plating film that becomes conductive layer 11 is deposited on substrate 2, and fine metal particles 4 made of the same metal as the plating film grow below conductive layer 11. That is, the metal included in conductive layer 11 and the metal included in fine metal particles 4 are the same. In the present embodiment, the metal included in conductive layer 11 and the metal included in fine metal particles 4 are both copper nickel alloys.

In addition, both conductive layer 11 and fine particle layer 2b are formed by simultaneously growing metal deposited by catalyst 4a, but it is considered that conductive layer 11 is an alloy film with a dense film structure because it is formed by the growth of copper and nickel without restriction, while fine particle layer 2b is a layer including countless fine metal particles 4 because copper and nickel grow with restriction inside substrate 2, which is a resin substrate. For this reason, it is considered that the interface between conductive layer 11 and fine particle layer 2b becomes an uneven structure. In addition, fine particle layer 2b has a rougher film quality than conductive layer 11.

It should be noted that although not shown, after conductive layer 11 is formed in substrate 2, a baking treatment is performed. This reduces the internal stresses of fine particle layer 2b and conductive layer 11, and allows dehydration. It should be noted that the heating temperature for the baking treatment is, for example, 100° C.

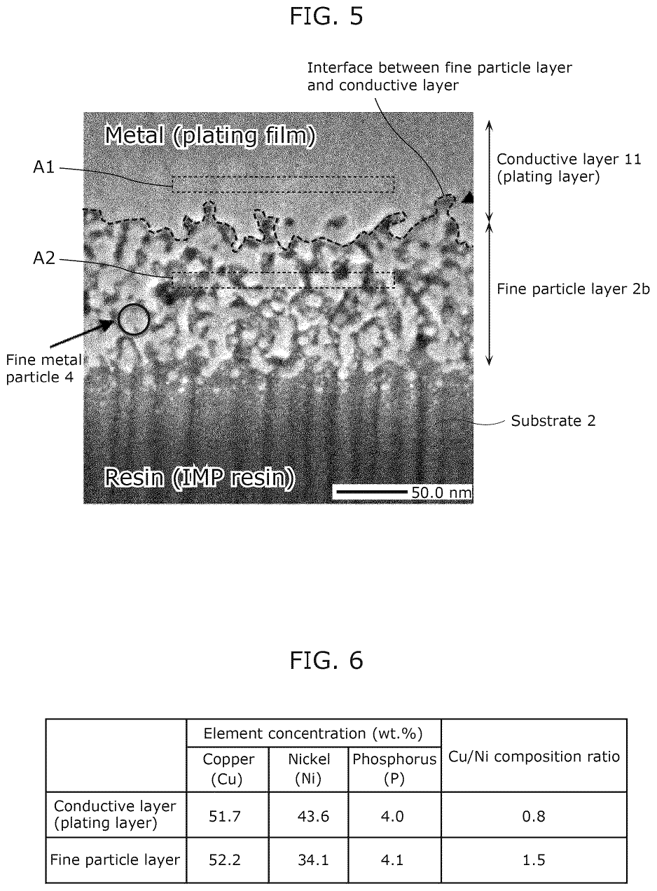

FIG. 5 is a cross-sectional scanning electron microscope (SEM) image of a part of conductive film 1 actually produced by the above method. FIG. 5 shows the surrounding portion of fine particle layer 2b.

As shown in FIG. 5, it can be confirmed that conductive layer 11 and substrate 2 are in contact with each other via fine particle layer 2b. In addition, it can be confirmed that fine particle layer 2b and conductive layer 11 have different film structures, and that fine particle layer 2b includes countless fine metal particles 4. Furthermore, it can also be confirmed that the interface between conductive layer 11 and fine particle layer 2b has an uneven structure.

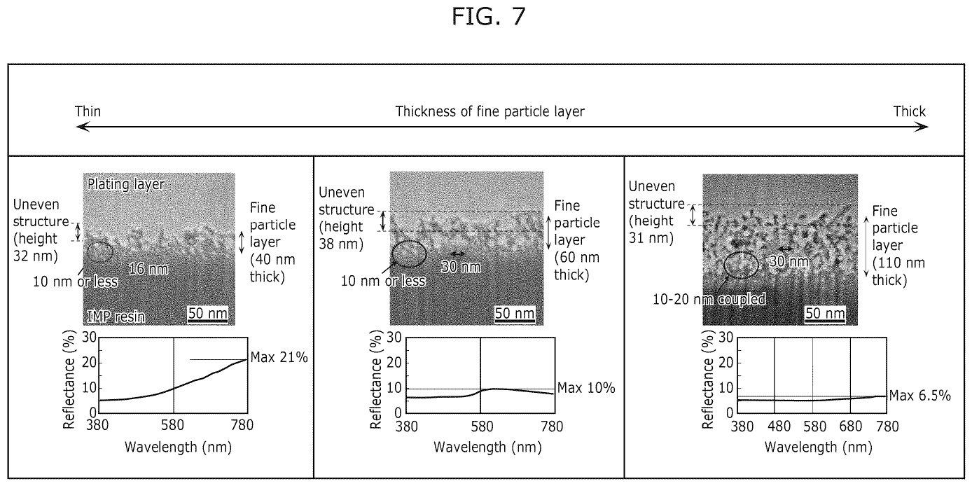

In addition, FIG. 6 shows the results of composition analysis of metals in conductive layer 11 and fine particle layer 2b in conductive film 1 actually produced. In FIG. 6, the composition of conductive layer 11 shows the analysis results of region A1 surrounded by the dashed line in FIG. 5, and the composition of fine particle layer 2b (that is, the composition of fine metal particles 4) shows the analysis results of region A2 surrounded by the dashed line in FIG. 5.

As shown in FIG. 6, it can be seen that both conductive layer 11 and fine particle layer 2b (fine metal particles 4) contain copper (Cu), nickel (Ni), and phosphorus (P) as metals. In addition, when the weight percent of Cu is “W_{Cu}”, the weight percent of Ni is “W_{Ni}” and the composition ratio of Cu and Ni (W_{Cu}/W_{Ni}) is “Cu/Ni composition ratio”, it was found that the Cu/Ni composition ratio of fine particle layer 2b (fine metal particles 4) is greater than the Cu/Ni composition ratio of conductive layer 11.

It should be noted that when a plurality of conductive films 1 having different film compositions of fine particle layer 2b were produced by varying the thickness of fine particle layer 2b or the like, it was also found that the Cu/Ni composition ratio of fine particle layer 2b (fine metal particles 4) was 0.1 to 1.8.

The thickness of fine particle layer 2b can be controlled, for example, by changing the conditions (output, time, and the like) when substrate 2 is irradiated with ultraviolet rays, changing the particle size of catalyst 4a, or changing the conditions (time and the like) when electroless plating treatment is applied, in the above manufacturing method.

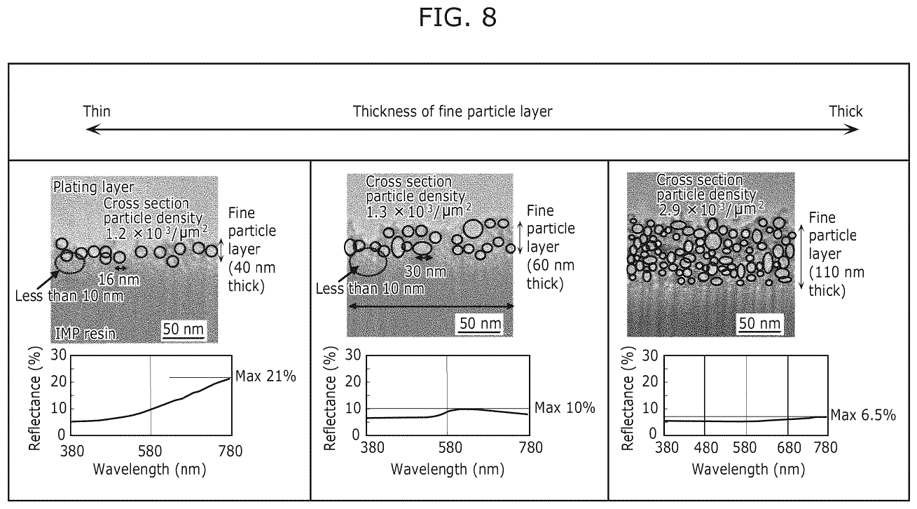

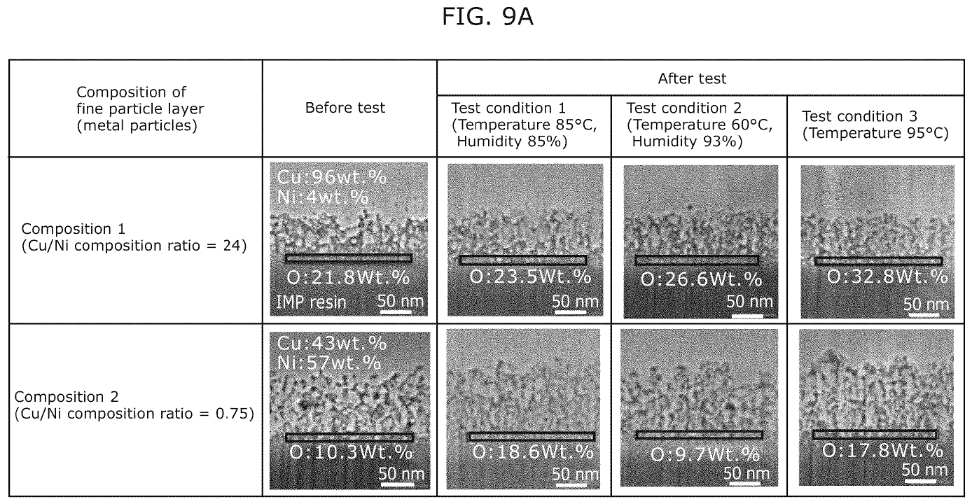

FIG. 7 and FIG. 8 show the wavelength dependence of the cross-sectional SEM images of the surrounding portions of fine particle layer 2b and the reflectance of three conductive films 1 actually produced by different thicknesses of fine particle layer 2b. The cross-sectional SEM image of FIG. 7 and the cross-sectional SEM image of FIG. 8 are the same, and correspond to the same portion as the cross-sectional SEM image shown in FIG. 5. It should be noted that the cross-sectional SEM images on the right side of FIG. 7 and FIG. 8 are the same as the cross-sectional SEM image in FIG. 5 (that is, it is a conductive film of the same sample).

As shown in FIG. 7, it can be seen that the thickness of fine particle layer 2b changes within a range between 30 nm and 150 nm. In this case, the surface roughness Ry of the uneven structures is at most 50 nm in any cases.

As shown in FIG. 7, it can be seen that the larger the thickness of fine particle layer 2b and the larger the particle size of fine metal particles 4, the more the maximum reflectance with respect to visible light (wavelengths of 380 nm to 780 nm) decreases. In particular, it can be seen that the reflectance in the high wavelength region decreases.

In this way, according to conductive film 1 in the present embodiment, the reflectance can be increased or reduced by controlling the thickness of fine particle layer 2b or the particle size of fine metal particles 4.

It should be noted that in FIG. 7, the thicker the fine particle layer 2b, the larger the particle size of fine metal particles 4, but the present disclosure is not limited thereto. That is, even if the thickness of fine particle layer 2b becomes thick, the particle size of fine metal particles 4 does not necessarily increase.

In addition, as shown in FIG. 8, when the cross-sectional density of fine metal particles 4 having a particle size of at least 10 nm among fine metal particles 4 contained in fine particle layer 2b is measured, it was found that the cross-sectional density (cross-sectional particle density) of each of the three samples was 1.2×10³ particles/μm², 1.3×10³ particles/μm², and 2.9×10³ particles/μm², and that the larger the thickness of fine particle layer 2b, the larger the cross-sectional density.

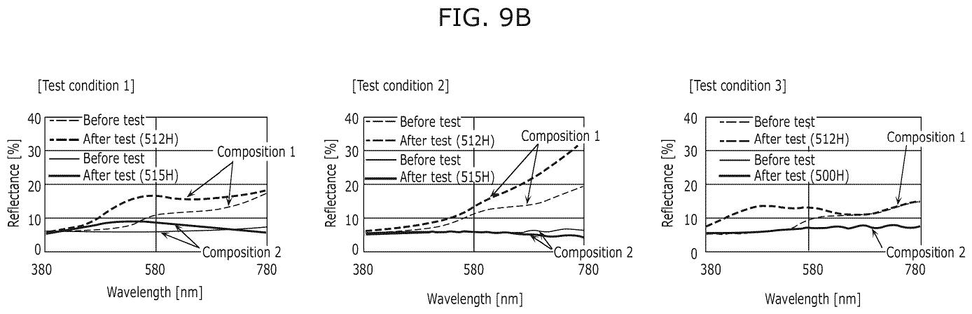

Next, a reliability test was performed on the relationship between the Cu/Ni composition ratio of fine particle layer 2b (fine metal particles 4) and the variation in the reflectance of conductive film 1, and the results of the test will be explained with reference to FIG. 9A and FIG. 9B. FIG. 9A shows cross-sectional SEM images before and after the test in samples of two types of conductive films with different compositions of fine particle layer 2b (fine metal particles 4). FIG. 9B shows the wavelength dependence of reflectance after the test in the samples of the two types of conductive films of FIG. 9A.

As shown in FIG. 9A, the composition (composition 1) of Cu and Ni in fine particle layer 2b of the first sample is 96 wt % of Cu, 4 wt % of Ni, and 24 of Cu/Ni composition ratio. The composition (composition 2) of Cu and Ni in fine particle layer 2b of the second sample is 43 wt % of Cu, 57 wt % of Ni, and 0.75 of Cu/Ni composition ratio.

These two samples were subjected to reliability tests under three test conditions, from test conditions 1 to 3. First test condition 1 is a temperature of 85° C. and a humidity of 85%, second test condition 2 is a temperature of 60° C. and a humidity of 93%, and third test condition 3 is a temperature of 95° C. (humidity is not controlled). The test period of time was 512 hours for each test.

When the reflectance of each sample after the test was measured, the results shown in FIG. 9B were obtained. As shown in FIG. 9B, it can be seen that the variation in reflectance is smaller for the sample with composition 2 than the sample with composition 1. That is, the sample including fine particle layer 2b with a high Ni to Cu ratio (the concentration of Ni relative to Cu) has a smaller variation in reflectance. This is thought to be due in part to the oxygen content concentration in fine particle layer 2b.

Here, when the oxygen content concentration of fine particle layer 2b in each sample before and after the test was measured, the results shown in FIG. 9A were obtained. FIG. 9A shows the oxygen content concentration of fine particle layer 2b in each sample. The oxygen content concentration of fine particle layer 2b of each sample indicates the oxygen content concentration of the portion surrounded by a solid line in the SEM cross-section of each sample.

As can be seen from comparing the oxygen content concentrations of fine particle layer 2b between the sample of composition 1 and the sample of composition 2, it can be seen that the oxygen content concentration of the sample of composition 2, which has a high Ni to Cu ratio, is lower. That is, the higher the Ni to Cu ratio of fine particle layer 2b, the more oxidation is suppressed. As a result, it is believed that the variation in reflectance in composition 2 is smaller.

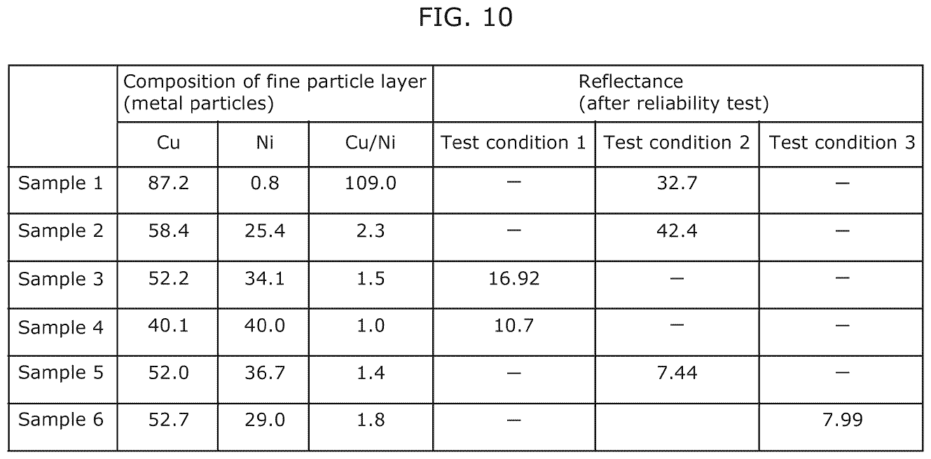

In addition, when the reflectance after the reliability test was measured for six samples (samples 1 to 6) with different Cu/Ni composition ratios in fine particle layer 2b, the results shown in FIG. 10 were obtained.

As shown in FIG. 10, it can be seen that the reflectance can be significantly reduced by setting the Cu/Ni composition ratio, which is the composition ratio of copper (Cu) and nickel (Ni), to at most 2 in fine particle layer 2b. Specifically, by setting the Cu/Ni composition ratio to at most 2, the reflectance can be reduced to at most 20%.

As explained above, conductive film 1 according to the present embodiment includes substrate 2 and conductive layer 11 provided on at least one surface of substrate 2, conductive layer 11 and substrate 2 are in contact with each other through fine particle layer 2b containing fine metal particles 4 that absorb light, and the interface between conductive layer 11 and fine particle layer 2b has an uneven structure.

This configuration allows light to be absorbed by fine particle layer 2b and diffusely reflected by the uneven structure at the interface between conductive layer 11 and fine particle layer 2b. This makes it possible to realize conductive film 1 having a structure that can reduce the reflectance at the interface between substrate 2 and conductive layer 11.

In addition, conductive film 1 having this structure can be manufactured simply by forming conductive layer 11 on substrate 2. Specifically, as mentioned above, by forming modified layer 2s as the surface layer of substrate 2, which is a resin substrate, and forming conductive layer 11 (plating film) on substrate 2 including modified layer 2s by the electroless plating method, fine particle layer 2b containing fine metal particles 4 can be formed as a low-reflective layer between conductive layer 11 and the resin base material included in substrate 2.

In this way, according to conductive film 1 according to the present embodiment, it is possible to obtain a structure in which the reflectance at the interface between substrate 2 and conductive layer 11 can be reduced without adding a black film.

In addition, in conductive film 1 according to the present embodiment, the density of fine metal particles 4 in fine particle layer 2b is higher than the density of fine metal particles 4 in substrate 2 (part of substrate 2 other than fine particle layer 2b).

This configuration allows the light absorption and scattering effects in fine particle layer 2b to be increased, and the reflectance at the interface between substrate 2 and conductive layer 11 can be further reduced.

In addition, in conductive film 1 according to the present embodiment, the thickness of fine particle layer 2b is less than that of conductive layer 11.

In this way, even if fine particle layer 2b is thin, the reflectance at the interface between substrate 2 and conductive layer 11 can be effectively reduced.

In addition, in conductive film 1 according to the present embodiment, the thickness of fine particle layer 2b is at least 30 nm and at most 150 nm, and the particle size of fine metal particles 4 is at least 10 nm and at most 30 nm.

This configuration enables light absorption and scattering effects in fine particle layer 2b to be effectively demonstrated, and thus the reflectance at the interface between substrate 2 and conductive layer 11 can be further effectively reduced.

In addition, in conductive film 1 according to the present embodiment, the cross-sectional density of the fine metal particles having a particle size of at least 10 nm contained in fine particle layer 2b is 1×10³ particles/μm² to 3×10³ particles/μm².

This configuration allows the light absorption and scattering effects in fine particle layer 2b to be more effectively demonstrated, and thus the reflectance at the interface between substrate 2 and conductive layer 11 can be further effectively reduced.

### (Variations)

The conductive film according to the present disclosure has been described above based on the embodiment, but the present disclosure is not limited to the above embodiment.

For example, in the above embodiment, the single component metals included in conductive layer 11 and fine particle layer 2b (fine metal particles 4) are Cu and Ni, but the present disclosure is not limited thereto. For example, the single component metals included in conductive layer 11 and fine particle layer 2b (fine metal particles 4) may include Co, Ru, Rh, Pd, Ag, Cd, In, Sn, Sb, Pt, Au, Pb, Bi, or the like. In addition, in the above embodiment, the alloy or metals of the additive components (components that are intentionally alloyed and added) included in conductive layer 11 and fine particle layer 2b (fine metal particles 4) is P, but the present disclosure is not limited thereto. For example, the alloy or metals of the additive components included in conductive layer 11 and fine particle layer 2b (fine metal particles 4) may include Fe, Cr, Mn, Zn, W, B, C, Si, or the like.

In addition, in the above embodiment, first wiring 10 is provided only on one surface of substrate 2, but the present disclosure is not limited thereto. Specifically, first wiring 10 may be provided on both surfaces of substrate 2. That is, conductive layer 11 and metal layer 12 may be provided on both surfaces of substrate 2. In this way, conductive layer 11 and metal layer 12 may be provided on at least one surface of substrate 2. It should be noted that second wiring 20 may also be provided on both surfaces of substrate 2.

In addition, in the above embodiment, first wiring 10 and second wiring 20 intersect three-dimensionally, but the present disclosure is not limited thereto. For example, first wiring 10 and second wiring 20 may be formed in the same layer. It should be noted that in the above embodiment, first wiring 10 and second wiring 20 intersecting three-dimensionally are insulated through insulating layer 3. However, contact portions (vias) may be formed at a part of a plurality of intersections between first wiring 10 and second wiring 20. That is, first wiring 10 and second wiring 20 may be electrically connected.

In addition, in the above embodiment, conductive film 1 is a wiring board that is light-transmissive, and can be used as a touch sensor board in a touch panel, but the present disclosure is not limited thereto. For example, conductive film 1, which is a wiring board that is light-transmissive, may be used as a mounting board in a display device including a plurality of LED elements arranged in a matrix, may be used as a connection board for electrically connecting electronic components together, may be used as an antenna board including wiring formed in a predetermined pattern as a pattern antenna such as a 5G antenna, or may be used as a heater board using wiring as an electric heating wire.

In addition, in the above embodiment, first wiring 10 and second wiring 20 are formed in conductive film 1, but the present disclosure is not limited thereto. For example, conductive film 1 may include only first wiring 10. In this case, first wiring 10 is formed in groove 2a formed in substrate 2, but the present disclosure is not limited thereto, and may be formed on the surface of substrate 2 where no groove 2a is formed.

In addition, in the above embodiment, conductive film 1 is used as a wiring board having wiring, but the present disclosure is not limited thereto. Specifically, conductive film 1 may be used for applications other than wiring boards. In this case, conductive film 1 may have a configuration in which only conductive layer 11 is formed above substrate 2 with fine particle layer 2b interposed therebetween.

In addition, forms obtained by applying various modifications to the above embodiment conceived by a person skilled in the art or forms realized by arbitrarily combining the components and functions in the embodiment without departing from the spirit of the present disclosure are also included in the present disclosure. In addition, the present disclosure also includes arbitrarily combining two or more claims from among a plurality of claims set forth in the claims at the time of filing the present application, within the scope in which they are not technically inconsistent. For example, when the cited claims set forth in the claims at the time of filing the present application are referred to as multiple claims or multiple-multiple claims so as to cite all of the higher-level claims within the scope in which they are not technically inconsistent, the present disclosure also includes combinations of all claims included in the multiple claims or multiple-multiple claims.

### INDUSTRIAL APPLICABILITY

The conductive film according to the present disclosure can be used in a variety of electrical equipment including touch panels and the like.

[Reference Signs List]

| | |
|---|---|
| 1 | Conductive film |
| 2 | Substrate |
| 2a | Groove |
| 2b | Fine particle layer |
| 2s | Modified layer |
| 3 | Insulating layer |
| 4 | Fine metal particle |
| 4a | Catalyst |
| 10 | First wiring |
| 11 | Conductive layer |
| 12 | Metal layer |
| 20 | Second wiring |
| 100 | Mold member |

1. A conductive film comprising:
a substrate that is light-transmissive; and
a conductive layer provided on at least one surface of the substrate,
wherein the conductive layer and the substrate are in contact with each other through a fine particle layer,
the fine particle layer includes fine metal particles that absorb light, and
an interface between the conductive layer and the fine particle layer has an uneven structure.

2. The conductive film according to claim 1,
wherein a density of the fine metal particles in the fine particle layer is higher than a density of fine metal particles that absorb light in the substrate.

3. The conductive film according to claim 1,
wherein a thickness of the fine particle layer is less than a thickness of the conductive layer.

4. The conductive film according to claim 1,
wherein a thickness of the fine particle layer is at least 30 nm and at most 150 nm, and
a particle size of the fine metal particles is at least 10 nm and at most 30 nm.

5. The conductive film according to claim 1,
wherein a cross-sectional density of the fine metal particles having a particle size of at least 10 nm contained in the fine particle layer is 1×10³ particles/μm² to 3×10³ particles/μm².

6. The conductive film according to claim 1,
wherein the fine metal particles include copper and nickel.

7. The conductive film according to claim 6,
wherein a Cu/Ni composition ratio is at most 2, the Cu/Ni composition ratio being a composition ratio of the copper and the nickel.

8. The conductive film according to claim 6,
wherein the conductive layer includes copper and nickel.

9. The conductive film according to claim 1,
wherein the substrate is a transparent resin substrate.

10. The conductive film according to claim 1, further comprising:
a metal layer stacked on the conductive layer.

11. The conductive film according to claim 10,
wherein the conductive film is a wiring board, and
the conductive layer and the metal layer are wiring embedded in a groove formed in the substrate.

12. The conductive film according to claim 11,
wherein the metal layer is a plating film formed with the conductive layer as an underlying layer.
